(19) United States
(12) Patent Application Publication
(10) Pub. No.: US 2024/0189811 A1
(43) Pub. Date: Jun. 13, 2024

(54) TUBE SET WITH DUAL PRESSURE REGULATING VALVE

(71) Applicant: RAPID MICRO BIOSYSTEMS, INC., Lowell, MA (US)

(72) Inventors: Blair MORAD, Ipswich, MA (US); Ethan FRANCO, Lowell, MA (US)

(21) Appl. No.: 18/538,085

(22) Filed: Dec. 13, 2023

Related U.S. Application Data
(60) Provisional application No. 63/387,172, filed on Dec. 13, 2022.

(51) Int. Cl. B01L 3/00

(52) U.S. Cl. CPC B01L 3/502; B01L 3/561; B01L 3/567; B01L 2300/047; B01L 2300/0681; B01L 2400/0487

(57) ABSTRACT

A microbe enumeration kit or system is provided that includes a number of cassettes with an upper and lower chamber separated by a membrane. The kit further includes a media reservoir fluidly coupled to the cassettes by a tube set and a dual pressure valve mechanically coupled to the tube set and arranged to change a pressure in the cassettes to cause fluid from the fluid reservoir to pass through or interact with the membrane.

### RELATED APPLICATIONS

This application claims priority and the benefit of U.S. Provisional Application No. 63/387,172, filed Dec. 13, 2022, the entire contents of which are incorporated herein by reference in its entirety.

### BACKGROUND

Many industries require the determination of the number or presence of microbes in a sample, often referred to as microbe enumeration or detection. One method of determining the number of microbes in a sample (or detecting the presence of microbes) involves exposing a filtration membrane to a sample to capture microbes in the sample on the membrane, culturing the microbes captured on the membrane, and optionally counting the number of colonies that grow during culturing.

Thus, membrane filtration is a commonly used method to concentrate and enumerate microorganisms present in a liquid sample. It allows for the filtration of a known volume of the sample through a membrane filter with a defined pore size, retaining microorganisms on the filter surface.

First, the liquid sample to be analyzed is typically diluted to reduce the microbial load and ensure the presence of single, isolated colonies on the filter. A membrane filter with an appropriate pore size is selected based on the expected size of the microorganisms being enumerated. Commonly used pore sizes are 0.45 μm or 0.2 μm.

The membrane filter is placed on a filter holder or manifold designed for microbial analysis. The filter holder is connected to a vacuum source, creating a pressure differential across the membrane. A known volume of the diluted sample is aseptically poured or pipetted onto the membrane filter, which is then placed on the filter holder. The vacuum is applied, and the liquid portion of the sample is drawn through the filter, leaving behind the microorganisms on the filter surface.

To ensure efficient recovery of microorganisms, the filter is rinsed or washed with an appropriate solution (such as sterile buffered saline) to remove any remaining sample residues or contaminants.

After filtration, the membrane filter containing the retained microorganisms is aseptically transferred to a suitable culture medium, such as agar plates or broth. The choice of medium depends on the specific requirements of the microorganisms being enumerated. The culture media containing the membrane filters are incubated under suitable conditions (temperature, time, and atmospheric conditions) to promote the growth of viable microorganisms. The incubation period is determined based on the expected growth characteristics of the target microorganisms.

After the incubation period, the membrane filters are examined, and visible microbial colonies that have grown on the filter surface are counted. The colonies are distinguished based on their characteristics, such as size, shape, color, and morphology. The colony counts obtained from the membrane filters are used to calculate the number of viable microorganisms in the original sample, taking into account the dilution factor and the volume of the filtered sample.

Membrane filtration is particularly useful when the sample volume is large, and the microbial load is low. It allows for concentrating microorganisms on the filter, enabling easier detection and enumeration of colonies compared to direct plating methods. The method is widely employed in various industries, including pharmaceuticals, food and beverage, water quality testing, and environmental monitoring.

An example of an automated processing system for microbial enumeration and/or detection is the GROWTH DIRECT™ system provided by RAPID MICRO BIOSYSTEMS™ of Lowell, Massachusetts.

There is a need to control physical characteristics of the membrane when exposing the membrane to the sample and in culturing the microbes on the membrane to ensure consistency in microbe enumeration.

### BRIEF SUMMARY

During microbe enumeration, a membrane (e.g., in a cassette, or the like) is exposed to a sample such that any microbes in the sample are captured on the membrane. In general, the present disclosure provides improvements to systems or kits used to capture microbes on a membrane for purposes of microbe enumeration. One challenge to microbe enumeration is controlling distribution of the sample across the membrane. Some conventional system use a vacuum to “draw” the sample into a chamber and across the membrane. One such vacuum system uses an open funnel containing the sample, which can introduce non-sample contaminants, thereby invalidating the enumeration process. Further, such system require that the membrane be kept under tension and further that a space is provided for the membrane to expand into.

The present disclosure provides an enclosed microbe enumeration kit (or system) that addresses the above issues to provide a more consistent microbe enumeration process. In particular, the present disclosure provides a system including a number of cassettes, where each cassette includes a membrane. The cassettes are fluidly coupled to an enclosed reservoir by a tube set. The tube set includes a dual state pressure valve arranged to provide that the membrane is maintained in a relatively “flat” state during exposure to the sample. Maintaining the membrane in a relatively flat state ensures that the entirety of the membrane is exposed to (or wet by) the sample. Additionally, the dual state pressure valve is arranged to ensure that rinse fluid is properly filtered through the membrane and that the sample remains in an intended chamber of the cassette during exposure of the membrane to the sample.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an embodiment of the subject matter in accordance with one embodiment.

FIG. 1B illustrates an embodiment of the subject matter in accordance with one embodiment.

FIG. 1C illustrates an embodiment of the subject matter in accordance with one embodiment.

FIG. 2 illustrates an embodiment of the subject matter in accordance with one embodiment.

FIG. 3 illustrates an embodiment of the subject matter in accordance with one embodiment.

FIG. 4 illustrates an embodiment of the subject matter in accordance with one embodiment.

FIG. 5 illustrates an embodiment of the subject matter in accordance with one embodiment.

FIG. 6 illustrates an embodiment of the subject matter in accordance with one embodiment.

FIG. 7 illustrates an embodiment of the subject matter in accordance with one embodiment.

### DETAILED DESCRIPTION

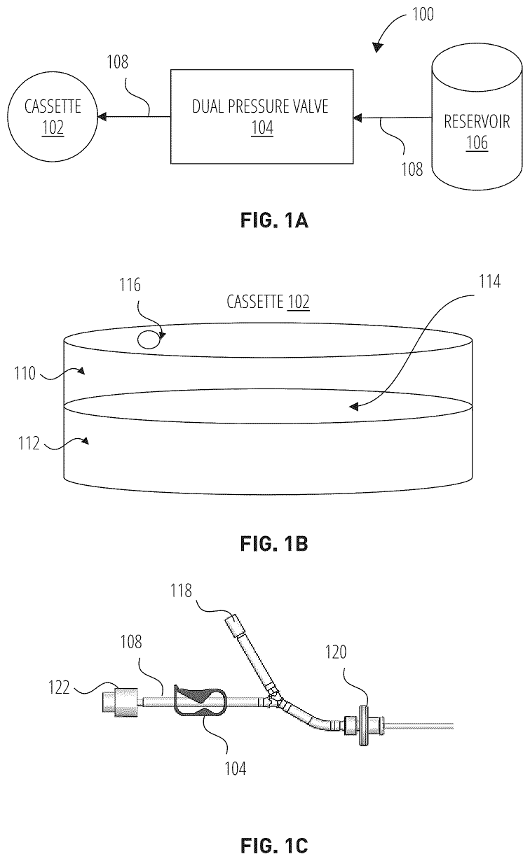

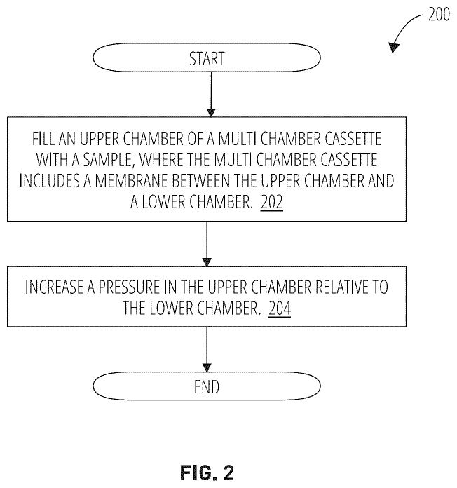

FIG. 1A illustrates a microbe enumeration system 100, that may be provided in accordance with embodiments of the present disclosure. The microbe enumeration system 100 includes a cassette 102, a dual pressure valve 104, and a reservoir 106 fluidly coupled by a tube set 108. In general, cassette 102 can be any of a variety of containers or apparatuses arranged to provide for growth of microbes while reservoir 106 is a fluid container arranged to hold rinsing fluid, a sample containing microbes, or the like. During use, fluid (not shown) from the reservoir 106 flows into the cassette 102 via tube set 108 while the dual pressure valve 104 maintains pressure in the cassette 102 at one of two pressure states to ensure that the cassette 102 fills with fluid from reservoir 106 in an intended fashion. This is explained in greater detail below.

FIG. 1B illustrates cassette 102 in greater detail. As depicted in this figure, cassette 102 includes and upper chamber 110 and a lower chamber 112 with a membrane 114 disposed between the chambers. One of the upper chamber 110 or lower chamber 112 can be filled with microbe growth media (e.g., nutrient broth, lysogeny broth medium, or the like). Further cassette 102 includes at least one port 116 with which tube set 108 can couple to allow fluid from reservoir 106 to flow into cassette 102.

In some embodiments, membrane 114 can be a filter arranged to capture microbes from a sample of fluid in the reservoir 106. The operation of membrane 114 may require a certain pressure to both ensure that the membrane remains tight (e.g., does not vibrate, or tear) and also is sufficiently covered by the fluid. As example process to capture microbes on membrane 114 is described below.

FIG. 1C illustrates dual pressure valve 104 in greater detail. As depicted in this figure, dual pressure valve 104 includes a manually operated clamp which, when engaged in one state, compresses the tube set 108 to cause the pressure on one side of the tube set 108 to be higher and when engaged in the other state allows the tube set 108 to expand reducing the pressure in the one side of the tube set 108. In some embodiments, the tube set 108 may include a vent 118 on one side of the dual pressure valve 104 arranged to stabilize the pressure in the tube set 108 on one side of the dual pressure valve 104 to atmospheric pressure, while the pressure in the tube set 108 on the other side of the dual pressure valve 104 is maintained at a higher pressure. Additionally, tube set 108 can include a flow restricter 120 arranged to restrict a fluid flow to below a certain pressure as well as a coupler 122 arranged to couple to port 116. In some embodiments, the coupler 122 may be a low-pressure check valve; in others, it may be open to atmosphere.

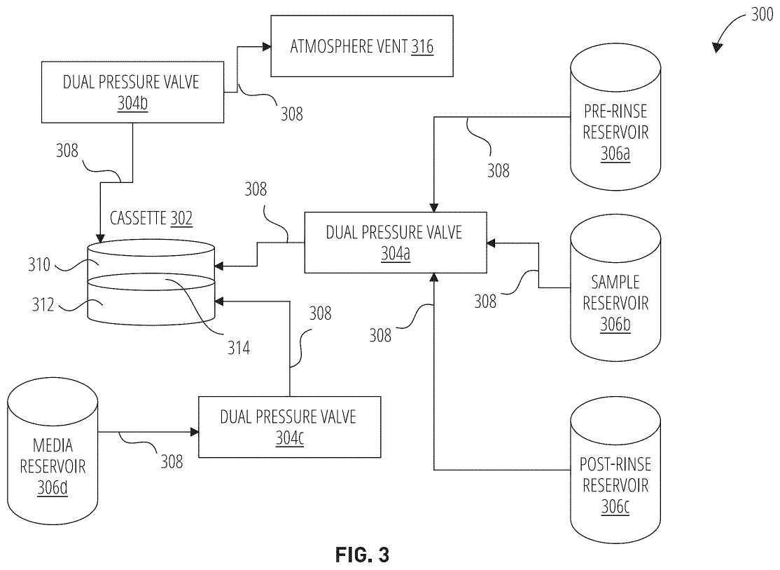

FIG. 2 illustrates a method 200 for processing a sample for purposes of microbe enumeration. Method 200 can be used with microbe enumeration system 100, or another system like the microbe enumeration system 100. In general, method 200 can be implemented to ensure that a membrane or filter (e.g., membrane 114 of microbe enumeration system 100) is sufficiently covered by a sample to capture microbes from the sample for purposes of microbe growth and enumeration. Method 200 can begin at block 200. At block 202 “fill an upper chamber of a multi chamber cassette with a sample, where the multi chamber cassette includes a membrane between the upper chamber and a lower chamber” upper chamber 110 is filled with fluid from reservoir 106. For example, reservoir 106 can be moved such that gravity causes fluid to flow from reservoir 106 through tube set 108 to upper chamber 110. With some examples, reservoir 106 can include one-way valves to allow air into reservoir 106 so that fluid can flow out. With a specific example, the reservoir 106 can include a filter and/or valve to inhibit the fluid in reservoir 106 from being contaminated with microbes from the air.

Continuing to block 204 “increase a pressure in the upper chamber relative to the lower chamber” pressure in upper chamber 110 can be increased relative to lower chamber 112 to cause fluid to sufficiently cover the membrane 114 and also to flow through the membrane 114 such that microbes in the fluid are captured by the membrane 114.

FIG. 3 illustrates a microbe enumeration system 300, in accordance with embodiments of the present disclosure. The microbe enumeration system 100 includes a cassette 302, dual pressure valves 304a, 304b, and 304c, and reservoirs 306a, 306b, 306c, and 306d fluidly coupled by a tube set 308. A number of different reservoirs are provided, such as, a pre-rinse reservoir 306a, sample reservoir 306b, post-rinse reservoir 306c, and media reservoir 306d. Sample reservoir 306b can contain a “sample” liquid, solid, gel, or aerosol medium, or said differently, a liquid medium to be analyzed with microbe enumeration as contemplated herein. Media reservoir 306d can include a liquid microbe growth medium. Microbe enumeration system 300 further includes an atmosphere vent 316 coupled to upper chamber 310 (although, in some embodiments, the atmosphere vent 316 may be omitted to allow for pressurized sample preparation). With some embodiments, microbe enumeration system 300 can include a fluid pump arranged to pump fluid in tube sets 308. However, for purposes of clarity, the fluid pump is not depicted in this figure.

During operation, fluid from reservoirs 306a, 306b, 306c, and 306d can flow (e.g., via pump action, via gravity, or the like) from the reservoirs into the cassette 302. Additionally, the dual pressure valves 304a, 304b, and 304c can be actuated to cause the pressure in upper chamber 310 to change relative to the pressure in lower chamber 312, or vice versa.

In another embodiment the media from media reservoir 306d may be run through the dual-pressure valve 304a. In these embodiments, the lower chamber 312 may be used as a vent-through.

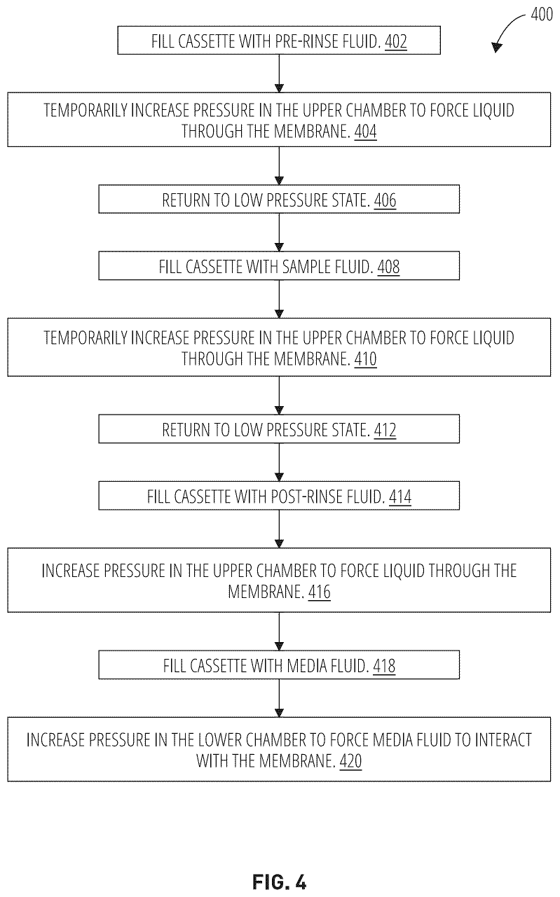

FIG. 4 illustrates a method 400, which can be implemented to capture microbes from a samples for purposes of microbe enumeration. Method 400 can be used with microbe enumeration system 300, or another system like the microbe enumeration system 300. In general, method 400 can be implemented to ensure that a membrane or filter (e.g., membrane 314 of cassette 302) is sufficiently covered by a sample (e.g., fluid from sample reservoir 306b) so as to capture microbes from the sample for purposes of microbe growth and enumeration.

The method 400 may be performed by a controller having a memory storing logic for performing the method, and a processor configured to execute the logic. The controller may be incorporated into the microbe enumeration system 300, or may be a separate device. Although FIG. 4 depicts a particular sequence of steps in a particular order, one of ordinary skill in the art will understand that the more steps may be performed in an exemplary method, some steps may be omitted, and/or steps may be performed in a different order.

Method 400 can begin at block 402. At block 402 “fill cassette with pre-rinse fluid” the cassette 302 can be filled with pre-rinse fluid from pre-rinse reservoir 306a. In particular, the upper chamber 310 of the cassette 302 can be filled with fluid from pre-rinse reservoir 306a during a period when the pressure in the upper chamber 310 is in a low state (e.g., less than or equal to 1.5 pounds per square inch (PSI) above atmosphere, between 0.5 and 1.5 PSI above atmosphere, or the like).

Continuing to block 404 “temporarily increase pressure in the upper chamber to force liquid through the membrane” the pressure in the upper chamber 310 can be temporarily increased to force fluid (e.g., the fluid added at block 402) in the cassette 302 through the membrane 314 and into the lower chamber 312. For example, the dual pressure valve 304b can be closed to pinch (or restrict) the tube set 308 between the upper chamber 310 and the atmosphere vent 316 to increase the pressure in the upper chamber 310. With some examples, closing the dual pressure valve 304b will increase the pressure between 0.5 and 4 PSI. With some embodiments, the pressure in the upper chamber can be increased for a set period of time (e.g., 30 seconds, 60 seconds, 90 seconds, or the like) while in other examples the pressure in the upper chamber can be increased until a condition is met (e.g., liquid flows through the membrane 314 into the lower chamber 312, or the like).

Continuing to block 406 “return cassette to low pressure state” the upper chamber 310 of cassette 302 can be returned to the low pressure state (e.g., less than or equal to atmosphere plus 1.5 PSI, or the like). Continuing to block 408 “fill cassette with sample fluid” the cassette 302 can be filled with sample fluid from sample reservoir 306b. In particular, the upper chamber 310 of the cassette 302 can be filled with fluid from sample reservoir 306b during a period when the pressure in the upper chamber 310 is in the low pressure state.

Continuing to block 410 “temporarily increase pressure in the upper chamber to force liquid through the membrane” the pressure in the upper chamber 310 can be temporarily increased to force fluid (e.g., the fluid added at block 408) in the cassette 302 through the membrane 314 and into the lower chamber 312. For example, the dual pressure valve 304b can be closed to pinch (or restrict) the tube set 308 between the upper chamber 310 and the atmosphere vent 316 to increase the pressure in the upper chamber 310. With some examples, closing the dual pressure valve 304b will increase the pressure between 0.5 and 4 PSI. With some embodiments, the pressure in the upper chamber can be increased for a set period of time (e.g., 30 seconds, 60 seconds, 90 seconds, or the like) while in other examples the pressure in the upper chamber can be increased until a condition is met (e.g., liquid flows through the membrane 314 into the lower chamber 312, or the like).

Continuing to block 412 “return cassette to low pressure state” the upper chamber 310 of cassette 302 can be returned to the low pressure state (e.g., less than or equal to atmosphere plus 1.5 PSI, or the like). Continuing to block 414 “fill cassette with post-rinse fluid” the cassette 302 can be filled with post-rinse fluid from post-rinse reservoir 306c. In particular, the upper chamber 310 of the cassette 302 can be filled with fluid from post-rinse reservoir 306c during a period when the pressure in the upper chamber 310 is in the low pressure state.

Continuing to block 416 “increase pressure in the upper chamber to force liquid through the membrane” the pressure in the upper chamber 310 can be increased to force fluid (e.g., the fluid added at block 414) in the cassette 302 through the membrane 314 and into the lower chamber 312. For example, the dual pressure valve 304b can be closed to pinch (or restrict) the tube set 308 between the upper chamber 310 and the atmosphere vent 316 to increase the pressure in the upper chamber 310. With some examples, closing the dual pressure valve 304b will increase the pressure between 0.5 and 4 PSI. With some embodiments, the pressure in the upper chamber can be increased for a set period of time (e.g., 30 seconds, 60 seconds, 90 seconds, or the like) while in other examples the pressure in the upper chamber can be increased until a condition is met (e.g., liquid flows through the membrane 314 into the lower chamber 312, or the like).

Continuing to block 418 “fill cassette with media fluid” the cassette 302 can be filled with media fluid from media reservoir 306d. In particular, the lower chamber 312 of the cassette 302 can be filled with fluid from media reservoir 306d during a period when the pressure in the upper chamber 310 is in the high pressure state.

Continuing to block 420 “increase pressure in the lower chamber to force media fluid to interact with the membrane” the pressure in the lower chamber 312 can be increased to force media fluid (e.g., the media fluid added at block 418) in the cassette 302 to interact with the membrane 314. For example, the dual pressure valve 304c can be closed to pinch (or restrict) the tube set 308 between the lower chamber 312 and the media reservoir 306d to increase the pressure in the lower chamber 312. Furthermore, the dual pressure valve 304a can be closed to pinch (or restrict) the tube set 308 between the other reservoirs and the upper chamber 310 to increase the pressure in the lower chamber 312. With some examples, the pressure in the lower chamber 312 can be raised between 0.5 and 4 PSI. With some embodiments, the pressure in the upper chamber can be increased for a set period of time (e.g., 30 seconds, 60 seconds, 90 seconds, or the like) while in other examples the pressure in the lower chamber can be increased until a condition is met (e.g., liquid stops moving through the tube set 308, or the like).

In some embodiments, method 400 can include a further step of disconnecting the cassette 302 from the tube set 308 and processing the cassette in a microbe culturing process (e.g., exposing to light, darkness, heat, moisture, or the like).

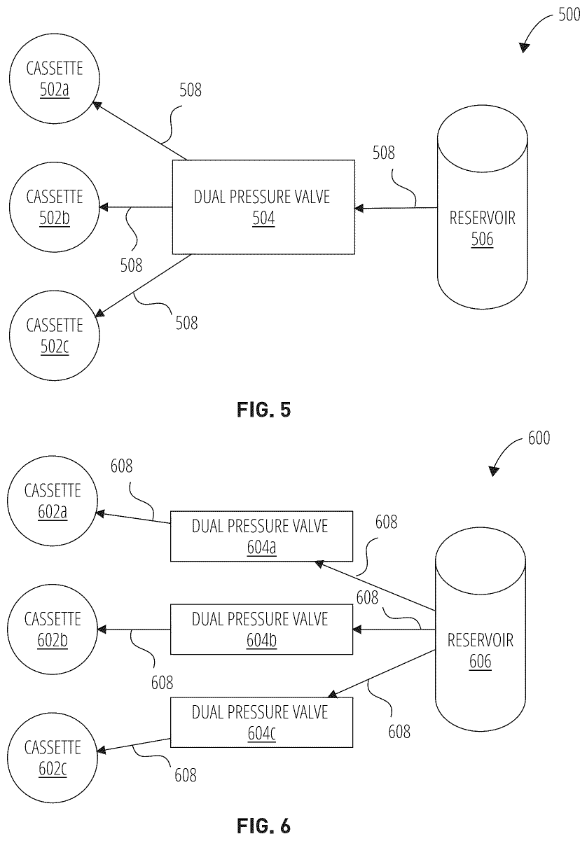

FIG. 5 illustrates a microbe enumeration system 500 including multiple cassettes. In particular microbe enumeration system 500 includes cassettes 502a, 502b, and 502c where each of the cassettes is coupled to reservoir 506 via tube set 508. Cassettes 502a, 502b, and 502c can be filled with fluid from reservoir 506 using a similar process as provided elsewhere herein (e.g., with respect to FIG. 2, FIG. 4, etc.). The tube set 508 is coupled (e.g., mechanically, or the like) to a single dual pressure valve 504, which can be utilized to effect a change in pressure in the cassettes 502a, 502b, and 502c as described elsewhere herein. Additionally, microbe enumeration system 500 can include multiple reservoirs 506 (e.g., like in microbe enumeration system 300 of FIG. 3, or the like).

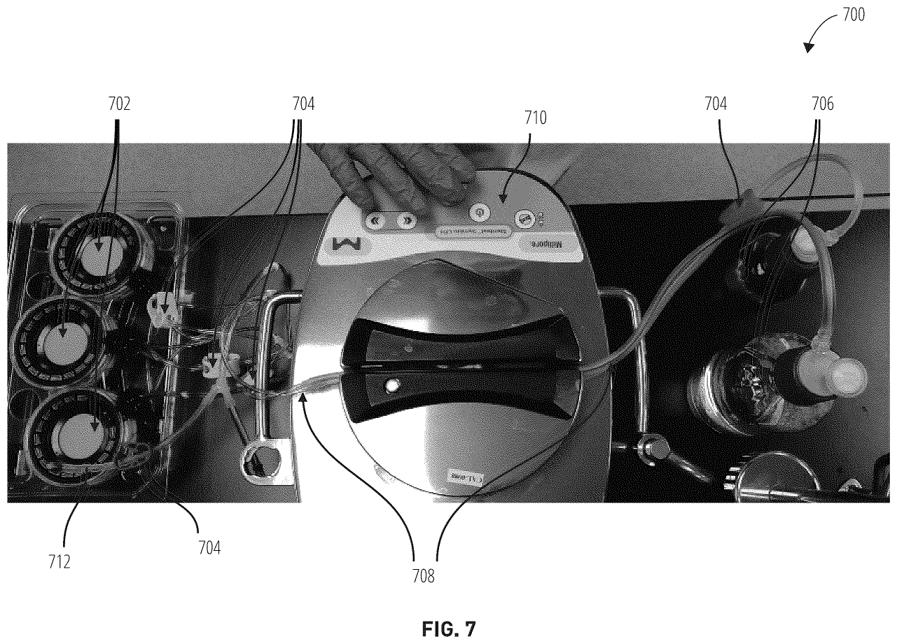

In other examples, multiple dual pressure valves 504 can be provided. For example, FIG. 6 illustrates microbe enumeration system 600 including cassette 602a, 602b, and 602c where each of the cassettes is coupled to reservoir 606 via tube set 608. Cassettes 602a, 602b, and 602c can be filled with fluid from reservoir 606 using a similar process as provided elsewhere herein (e.g., with respect to FIG. 2, FIG. 4, etc.). The tube set 608 is coupled (e.g., mechanically, or the like) to multiple dual pressure valves. In particular, tube set 608 is coupled to dual pressure valves 604a, 604b, and 604c. In this manner, pressure in cassette 602a, 602b, and 602c can be controlled individually.

As indicated above, in some embodiments, the example microbe enumeration systems (e.g., microbe enumeration system 100, microbe enumeration system 300, microbe enumeration system 500, microbe enumeration system 600, or the like) can include a pump. FIG. 7 illustrates a microbe enumeration system 700 in accordance with embodiments of the present disclosure. The microbe enumeration system 700 includes cassettes 702, dual pressure valves 704, and reservoirs 706 fluidly coupled by tube set 708. Furthermore, a pump 710 is provided to assist in moving (e.g., via capillary action, or the like) fluid from reservoirs 706 to cassettes 702 via tube set 708. Additionally, an atmosphere vent 712 is provided. During operation, fluid can flow from the reservoirs 706 into the cassettes 702. Additionally, the dual pressure valves 704 can be actuated to cause the pressure in the upper and/or lower chambers of the cassettes 702 to be increased or decreased as described herein to assist in wetting the membranes in the cassettes 702 with fluid from the reservoirs 706.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A method comprising:
filling at least one cassette with sample fluid;
increasing pressure in the at least one cassette;
reducing the pressure in the at least one cassette;
filling the cassette with media fluid; and
increasing the pressure in the at least one cassette.

2. The method of claim 1, wherein the cassette comprising an upper chamber, a lower chamber, and a membrane disposed between the upper and lower chambers, the method comprising:
filling the upper chamber of the at least one cassette with the sample fluid; and
increasing pressure in the upper chamber of the at least one cassette to force the sample fluid through the membrane into the lower chamber.

3. The method of claim 2, comprising:
filling the upper chamber of the at least one cassette with pre-rinse fluid; and
increasing the pressure in the upper chamber of the at least one cassette.

4. The method of claim 2, comprising
filling the upper chamber of the at least one cassette with post-rinse fluid; and
increasing the pressure in the upper chamber of the at least one cassette.

5. The method of claim 2, comprising:
filling the lower chamber of the at least one cassette with the media fluid, the media fluid being a solid, liquid, gel, gas, or aerosol; and
increasing the pressure in the lower chamber of the at least one cassette to force the media fluid to interact with the membrane.

6. The method of claim 2, wherein the pressure in the upper chamber is increased by greater than or equal to 1 pound per square inch (PSI) or by greater than or equal to 4 PSI.

7. A system comprising:
at least one cassette;
a fluid reservoir;
a tube set fluidly coupling the fluid reservoir to the at least one cassette; and
a dual pressure valve mechanically coupled to the tube set and arranged to change a pressure in the at least one cassette.

8. The system of claim 7, further comprising a controller configured to:
cause the at least one cassette to be filled with sample fluid;
increase a pressure in the at least one cassette;
reduce the pressure in the at least one cassette;
cause the at least one cassette to be filled with media fluid; and
increase the pressure in the at least one cassette.

9. The system of claim 7, wherein the cassette comprises an upper chamber, a lower chamber, and a membrane disposed between the upper and lower chambers.

10. The system of claim 9, wherein the controller is further configured to:
cause the upper chamber of the at least one cassette to be filled with the sample fluid; and
increase pressure in the upper chamber of the at least one cassette to force the sample fluid through the membrane into the lower chamber.

11. The system of claim 7, wherein the controller is further configured to:
cause the upper chamber of the at least one cassette to be filled with pre-rinse fluid; and
increase the pressure in the upper chamber of the at least one cassette.

12. The system of claim 7, wherein the controller is further configured to:
cause the upper chamber of the at least one cassette to be filled with post-rinse fluid; and
increase the pressure in the upper chamber of the at least one cassette.

13. The system of claim 7, wherein the controller is further configured to:
cause the lower chamber of the at least one cassette to be filled with the media fluid, the media fluid being a solid, liquid, gel, gas, or aerosol; and
increase the pressure in the lower chamber of the at least one cassette to force the media fluid to interact with the membrane.

14. The system of claim 7, wherein the pressure in the upper chamber is increased by greater than or equal to 1 pound per square inch (PSI) or by greater than or equal to 4 PSI.
